(19) United States
(12) Patent Application Publication
(10) Pub. No.: US 2013/0179286 A1
(43) Pub. Date: Jul. 11, 2013

(54) Business method to reduce costs resulting from returning of unwanted merchandizes from customers

(71) Applicant: Kung H. Lee, Chadds Ford, PA (US)

(72) Inventor: Kung H. Lee, Chadds Ford, PA (US)

(21) Appl. No.: 13/374,695

(22) Filed: Jan. 9, 2012

(51) Int. Cl. G06Q 30/00

(52) U.S. Cl. 705/26.1

(57) ABSTRACT

This invention relates to a business method for reducing costs resulting from returning of unwanted merchandizes from customers. The method involves interacting with the final merchandize recipient prior to shipment of the merchandize.

### CROSS-REFERENCE TO RELATED APPLICATIONS

This invention claims priority under 35 USC/119(e) to U.S. Provisional Patent Application 61/462,676 filed Feb. 7, 2011.

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not applicable”

### BACKGROUND OF THE INVENTION

Current U.S. Class: 705/500; 705/27.1; 705/65; 705/14.53

Current International Class: G06Q 30/00 (20060101); G06F 017/60

Field of Search: 705/500; 705/7,10,14,26,27,65

### REFERENCE CITED

### U.S. Patent Documents

| | | |
|---|---|---|
| 7,860,803 | December 2010 | Chang, et al. |
| 7,689,465 | March 2010 | Shakes, et al. |
| 6,963,848 | November 2005 | Brinkerhoff |
| 6,102,287 | August 2000 | Matyas, Jr. |
| 6,092,049 | July 2000 | Chislenko, et al. |
| 5,956,693 | September 1999 | Geerlings |
| 5,950,172 | September 1999 | Klingman |

### BRIEF SUMMARY OF THE INVENTION

This invention relates to a business method which enables merchants to reduce costs resulting from returning of unwanted merchandizes from customers.

Cited U.S. patents failed to teach such a cost saving method under the circumstances described.

### DETAILED DESCRIPTION OF THE INVENTION

In internet commerce, a customer orders, on-line, a merchandize as a gift for a third party (such as friend, a parent, etc.). There is a great probability the third party may not like the merchandize as ordered (and subsequently receives) for numerous reasons such as size, color, design, etc. Under such circumstances, the unwanted merchandize is normally returned to the merchant for exchange for something more suitable to the third party (the so-called secondary customer). Costs incurred in such returning of merchandize are substantial and the need to reduce this cost is great in order to protect the merchant's profit margin.

The best way to minimize such merchandize returns is to make an effort to do due diligence, assessing the gift recipient's (or the so-called secondary customer's) likes, tastes, etc. before making the actual merchandize shipment. Such due diligence effort can be promoted as an extra customer service to the merchandizer purchaser (or the so-called primary customer). Therefore, it is preferred to follow the following steps:

1. Infrom the customer that the merchant offers a service to perform due diligence (if the customer so desires) to help make sure that the gift recipient (the so-called secondary customer) will like the gift and thus, reduce the probability of returning the gift.
2. Upon acceptance of this offer, a due diligence is performed based on available information in the public domain.
2. With approval of the customer (presumably already obtained during step #1), inform the gift recipient (the so-called secondary customer)—in a surprise manner, if the gift should be a surprise event—that such a gift is forthcoming, with detailed description of the gift so that the gift recipient (the so-called secondary customer) can make an intelligent decision that the gift will be acceptable and will not be returned. Provide an opportunity for the gift recipient (the so-called secondary customer) to respond—to make changes or give approval to ship.
4. Make shipment when approval is received from the gift recipient (the so-called secondary customer).
5. Make sure the customer (the so-called primary customer) is fully informed during the above steps.
6. Make sure both customers (the so-called primary customer and the so-called secondary customer) are fully informed regarding details of packaging, labeling, loading and shipping so that both customers can trace the entire journey of this gift package from the warehouse to its finally destination.

The cited U.S. patents failed to teach such a cost saving method under the circumstances described.

U.S. Pat. No. 7,860,803 discloses a way to request and receive product reviews from the so-called primary customer, not only after the product shipment has been made, but also after the customer has received the product and used it. This current invention , to the contrarily, involves a so-called secondary customer and all the activities occur before the product is actually shipped.

U.S. Pat. No. 7,689,465 describes a system and method for visual verification of order processing with virtually no opportunity for the so-called primary customer to render inputs. This is basically a one-way information transfer from the merchant to the the so-called primary customer. This one-way information transfer is being made simultaneously while the product shipment is being made. To the contrarily, this current invention engages a two-way communication between the merchant and the customers, involving both the so-called primary customer and the so-called secondary customer. And all the activities occur before the product is actually shipped.

I claim:

1. A business method to reduce costs resulting from returning of unwanted merchandizes from customers.
1a. The method involves interacting with the final merchandize recipient prior to shipment of the merchandize.
